(19) United States
(12) Patent Application Publication
(10) Pub. No.: US 2009/0187980 A1
(43) Pub. Date: Jul. 23, 2009

(54) METHOD OF AUTHENTICATING, AUTHORIZING, ENCRYPTING AND DECRYPTING VIA MOBILE SERVICE

(76) Inventor: Tien-Chun TUNG, Taipei City (TW)

Correspondence Address: SCHMEISER, OLSEN & WATTS, 22 CENTURY HILL DRIVE, SUITE 302, LATHAM, NY, 12110, US

(21) Appl. No.: 12/017,358

(22) Filed: Jan. 22, 2008

(51) Int. Cl. G06F 21/00; G06F 17/00; H04L 9/32

(52) U.S. Cl. 726/6; 726/12; 726/10

(57) ABSTRACT

The present invention provides a method of authenticating, authorizing, encrypting and decrypting an application by utilizing a mobile secure server as the platform that can allow the subscriber to authenticate, authorize, encrypt or decrypt a document or an application through the mobile secure server. The account user can register and activate the service to have a secure banking transaction, such as online payment. A request message is submitted via an electronic device to an application server, which performs specific operations in accordance with the instruction of the request message, and sends the request message to the mobile secure server, wherein the mobile secure server will forward the request message to the account mobile telecommunication device that hosts the digital ID and certificates to be sued to authenticate, authorize, encrypt or decrypt the request message and then sends back a reply message to electronic device via the account mobile telecommunication device, application server and mobile secure server.

### BACKGROUND OF THE INVENTION

1. Field of Invention

The present invention relates a method of authenticating, authorizing, encrypting and decrypting application through the mobile service. More particularly, the present invention relates a method of utilizing the mobile secure server and mobile telecommunication devices to authenticate, authorize, encrypt and decrypt documents and information.

2. Description of the Related Art

In recent years, it has become common for digital information, documents, images or computer programs via network, such as the Internet, or portable recording mediums. Although digital data has a lot of advantage, its copyright and information is easily subjected to illegal acts such as unauthorized copying or tampering or illegal access. The security of the information becomes very important to ensure its confidentiality, and to be transmitted to and from a destination without it being stolen and used or revised by a third party. Therefore, reliability and fast transmitting service are both required in the electronic commerce in order to ensure fast transaction/transmission taken place and the security of the information.

Current existing systems or servers may choose the simply login authentication and authorization approaches, such as the credit card online payment, or choose more advanced Public Key Infrastructure (PKI) related methods and use the digital ID and certificates to authenticate, authorize, encrypt and encrypt the information or digital data. Those digital ID and certificates are stored in a password protected certificate reservoir in the conventional methods. The current popular devices to hole the certificates and digital ID are hard disk or soft disk in a computer, a Hardware Specific Module (HSM), or a smart card, a token, or other saving elements.

However, in those conventional systems and methods, the plain-text-long-in name and password or credit card information can be easily stolen or revised by the third party. The digital information such as digital ID and certificates kept in the computer hard disks also have high risk of being illegal tampered or illegal accessed. In other words, those conventional systems and methods can be easily compromised once the account or the user information is stolen or exposed to the public.

For those advanced systems using special devices to provide the authentication and authorization induce high fabrication cost, high distribution, and high maintaining cost. The removable soft disk in the computer, the hardware specific module (HSM), the smart card, and the token are all costly and difficult to maintain. Further, most of those devices are not compatible to each other, and are usually locked to each individual application. Thus, the users are forced to carry multiple special devices if they subscribe to multiple applications.

The conventional PKI locks the certificates with a target computer in such so to allow only the target computer to access to the certificates. However, by keeping the processing data and certificates in the same device is more likely to be stolen and illegal accessed by others. The conventional PKI is not suitable for the users who use the public computers. Therefore, it is inconvenience for the user who travels to different places.

Furthermore, for separate special devices, it is possible that they fail to work with alien electronic devices, such as a public computer without USB interface. Therefore, it is not convenient to use those conventional systems or devices that are not reliable, compatible and cumbersome operations.

Therefore, it is the objective of the present invention to provide an easy and very convenient method that can authenticate, authorize, encrypt and decrypt the application.

### SUMMARY OF THE INVENTION

It is an object of the present invention to provide a method of authenticating, authorizing, encrypting and decrypting an application by utilizing a mobile secure server as the platform. The method of the present invention can allow the subscriber to authenticate, authorize, encrypt or decrypt a document or an application through the mobile secure server.

The method of the present invention can be used in the banking situation to allow the account user to register and activate the service to have a secure banking transaction, such as the online payment service. The mobile secure server of the present invention is utilized to allow the user to submit a request message via an electronic device to an application server, which performs specific operations in accordance with the instruction of the request message, and sends the request message to the mobile secure server, wherein the mobile secure server will forward the request message to the account mobile telecommunication device that hosts the digital ID and certificates to be used to authenticate, authorize, encrypt or decrypt the request message and then sends back a reply message to electronic device via the account mobile telecommunication device, mobile secure server and application server.

The connection and communications of the present invention between the electronic device, the application server, the mobile secure server and the mobile telecommunication device are provided by data/phone routing/switching service such as Internet, Intranet, or telecommunication networks.

The method of authenticating, authorizing, encrypting and decrypting an application by utilizing a mobile secure server in accordance with one of preferred embodiments of the present invention, comprises:
a initiating an application request through an electronic device, and entering a user' account information;
b submitting the application request and the user's account information to the application server;
c verifying the user's account information, and determining whether the user's account has been registered to the mobile secure service, if it is yes, the system will go to step (e), if it is no, the system will go to step (d);
d terminating the verifying process as the user's account does not need the mobile secure service;
e checking whether the mobile secure service has been activated, if it is no, the system will go to step (f), if it is yes, the system will go to step (i);
f checking whether the activation time-limited of the mobile secure service is expired via the application server, if is yes, the system will go to step (h), if is no, the system will go to step (g);
g asking the user to activate the mobile secure service through the application server;
h prompting the user to register to the mobile secure service again due to the activation time-limited is expired for the security reason;
i responding to the application request by encrypting a request message with the utilization of an account certificate, and signing the request message by using the application server's digital ID and sequentially sending the request message to the mobile secure server;
k confirming whether the user's mobile telecommunication device is online, if no, the system will go to step (l), if yes, the system will go to step (n);
l sending an online notice message to the user's mobile telecommunication device via the mobile secure server;
m executing the client' software on the user's mobile telecommunication device to go online;
n sending the request message to the user's mobile telecommunication device from the mobile secure server;
o verifying the signature of the request message by using the application server's certificate stored in the certificate reservoir of the mobile telecommunication device, and requesting the user to enter a protective access code to retrieve the account digital ID in the certificate reservoir for decrypting the request message, and displaying the request message on the user's mobile telecommunication device and waiting for user's instruction, such as “reject” or “accept” the request message;
p coping the request message as the reply message when the user choose to either accept or reject the request message, and swapping the “To” and “From” fields in the reply message, and using a method specified in a “Handler identifier” field of the request message to process the request message, and completing and signing the reply message by using the account digital ID together with the user's choice to send the reply request to the mobile secure server, and then forwarding the reply message to the application server from the mobile secure server;
q verifying the signature on the reply message by using the account certificate kept in the application server, and processing the reply message and notifying the electronic device; and
r acknowledging the notification from the application server, and proceeding the operations via the electronic device accordingly.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 is a block diagram showing a method of authenticating, authorizing, encrypting and decrypting an application;

FIG. 2 is a flow diagram of a method of authenticating, authorizing, encrypting and decrypting an application by utilizing a mobile secure server in accordance with a first preferred embodiment of the present invention;

FIG. 3 is a flow diagram illustrating of applying and activating the method of authenticating, authorizing, encrypting and decrypting an application by utilizing a mobile secure service in accordance with a second preferred embodiment of the present invention;

FIGS. 4A and 4B are flow diagrams showing the processes of the method of authenticating, authorizing, encrypting and decrypting an application by utilizing a mobile secure service with a connection to a user mobile telecommunication device in accordance with a third preferred embodiment of the present invention.

### DESCRIPTION OF THE PREFERRED EMBODIMENTS

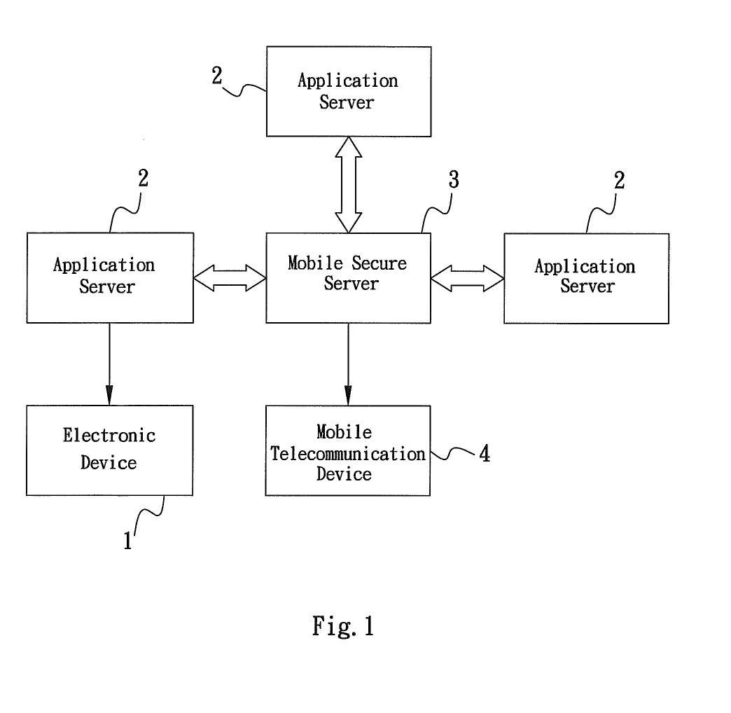

The present invention provides a method of authenticating, authorizing, encrypting and decrypting an application by utilizing a mobile secure server as a gateway between the application server and a mass of registered mobile telecommunication devices. Refer to FIG. 1, block diagram showing the method of the present invention comprises an application system, in which the application system further comprises an electronic device 1 connected to an application server 2. The electronic device 1 is utilized to send a request to the application server 2. The electronic device 1 of the present invention can be a computer, a personal digital assistance (PDA), a printer, a cash register, a cell phone or other similar devices. The request of the present invention can be the information or an object that is required to be authenticated, authorized, encrypted or decrypted, wherein the request does not limit by the information content or different types of codes, or various kinds of information or the size of the information.

A mobile secure server 3 is connected to the application server 2 to offer the mobile communication service to their account users, and it engages with a mass of specified mobile telecommunication device 4. The request received by the application server 2 is transmitted to the mobile secure server 3 and be forwarded to the specified mobile telecommunication device 4 sequentially. The application server 2 can modifies the database according to the user account with a certificate and the specified mobile telecommunication device 4. On the other hand, the mobile secure server 3 functions as the gateway between the application server 2 and the specified mobile telecommunication device 4. The mobile secure server 3 actually keeps no account information or the content of the application requests to ensure the secure transmission between the application server 2 and the specified mobile telecommunication device 4. The mobile secure server 3 is connected to the specified mobile telecommunication device 4 via an intermediate transmission, such as a phone, a data routing, a switching service, by an identification code, wherein the intermediate transmission can be wired or wireless or a combination of both to electrically connect to the mobile secure server 3 and the specified mobile telecommunication device 4.

The roles of application server 2 and the specified mobile telecommunication device 4 can be determined in accordance with various needs of the preferred embodiments. The specified mobile telecommunication device 4 can also be a physical device such as a computer, a personal digital assistance (PDA), a printer, a cash register, a cell phone or other similar devices. In other words, the specified mobile telecommunication device 4 is preferably the mobile electronic device, which consists of specific identification code or number that can identify the mobile electronic device in order to permit the communication. The specified mobile telecommunication device 4 then authenticates, authorizes, encrypts or decrypts the application request by utilizing the digital identification (ID) and certificates stored in the mobile telecommunication device 4.

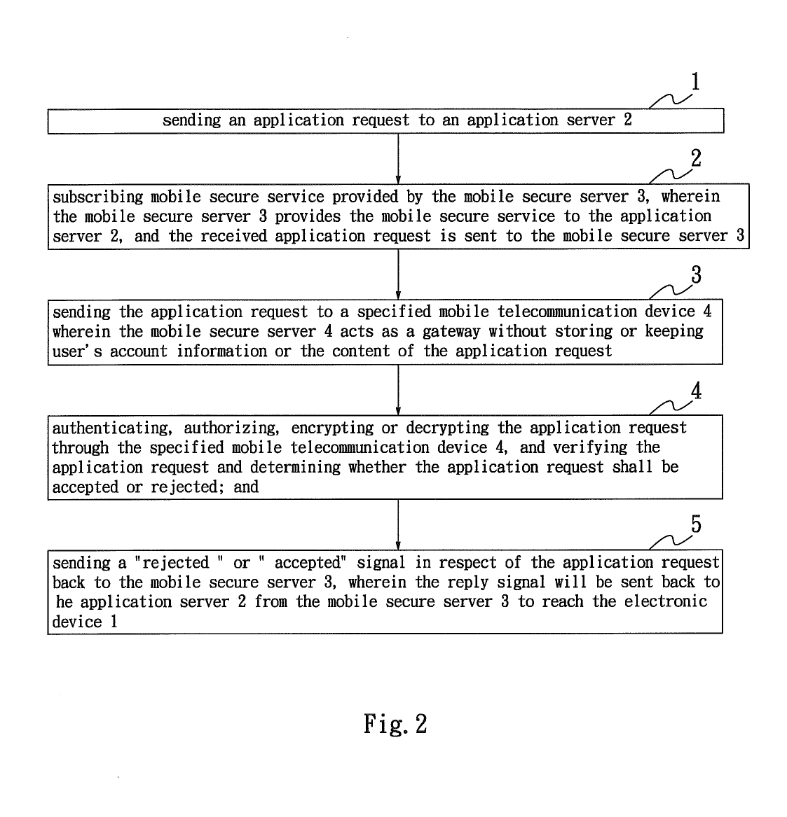

Refer to FIG. 2, the flow diagram showing the method of authenticating, authorizing, encrypting and decrypting an application by utilizing a mobile secure server in accordance with a first preferred embodiment of the present invention, comprises:
1. sending an application request to the application server 2 from the electronic device 1 used by a user;
2. subscribing the mobile secure service provided by the mobile secure server 3, wherein the mobile secure server 3 provides the mobile secure service to the application server 2, and the received application request is sent to the mobile secure server 3;
3. sending the application request to the specified mobile telecommunication device 4, wherein the mobile secure server 3 of the present invention acts as a gateway without storing or keeping user's account information or the content of the application request;
4. authenticating, authorizing, encrypting or decrypting the application request through the specified mobile telecommunication device 4, which contains the certificates, digital ID and the necessary software to verify the application request and determine whether the application request shall be accepted or rejected; and
5. sending a “rejected “or “accepted” signal in respect of the application request back to the mobile secure server 3, wherein the reply signal will be sent back to the application server 2 from the mobile secure server 3 to reach the electronic device 1.

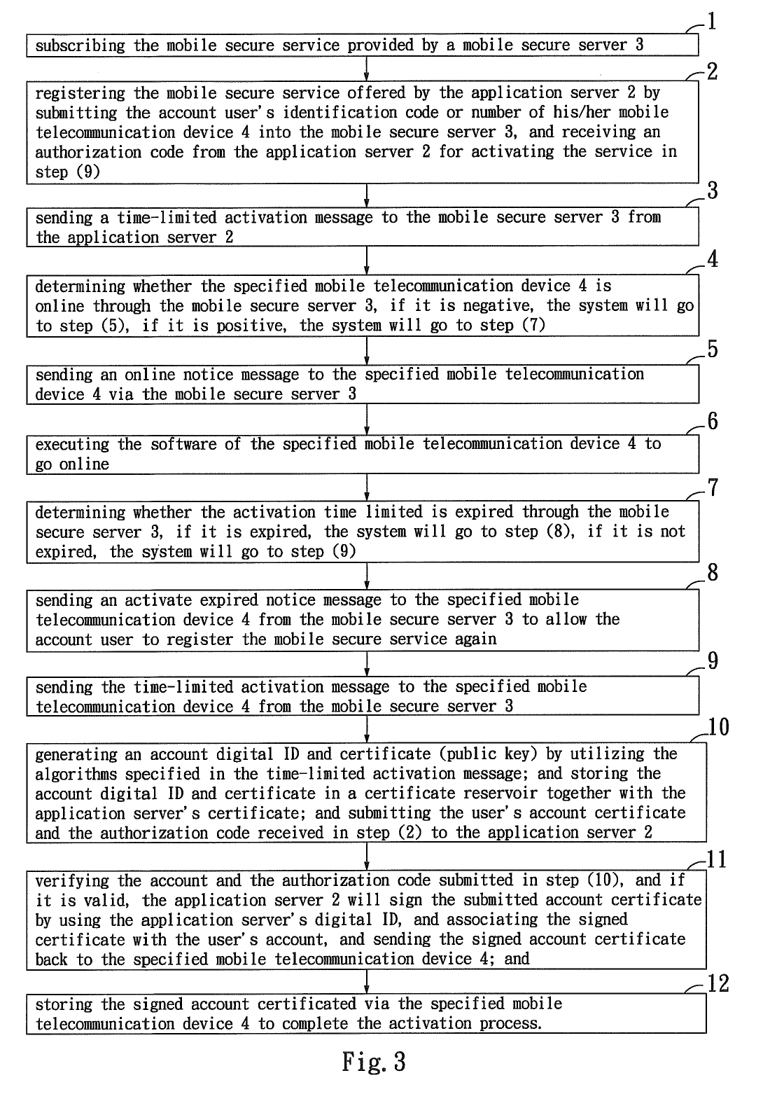

FIG. 3, the flow diagram shows how the method of authenticating, authorizing, encrypting and decrypting an application is applied and activated by utilizing a mobile secure service in accordance with a second preferred embodiment of the present invention, comprises:
1. subscribing the mobile secure service provided by the mobile secure server 3, wherein the application server 2 is connected to the mobile secure service via the mobile secure server 3, and certificates are exchanged to establish a secure communication between the application server 2 and the mobile secure server 3;
2. registering the mobile secure service offered by the application server 2 by submitting the account user's identification code or number of his/her mobile telecommunication device 4 and other required information or data into the application server 2, and receiving an authorization code from the application server 2 to approve the registration, wherein when the account user receives the authorization code, the account user can activate the mobile secure service via the software used in the mobile telecommunication device 4, or it allows the account user to download the software from a given Universal Resource Locator (URL), or to transmit the software to the mobile telecommunication device in order to execute the software to go online;
3. sending a time-limited activation message to the mobile secure server 3 from the application server 2, wherein the application server 2 prepares, signs and sends the time—limited activation message to the mobile secure server 3 and then to the specified mobile telecommunication device 4, in which the activation message comprises the “to” and “from” fields to designate the receiver and the sender, for an example, to “phone_no@MobileSecureServer” and from “account@application.server” by using the user@domain syntax, and other application information such as, the certificate of the application server 2, the application URL for submitting the account certificate, the application approved algorithms for generating digital ID/certificate (different applications may have different algorithms), the time-limited indicates that the specific period of the time that the activation must be carried out or completed, the activation message is self-sustained and needs no other information for activating the account's mobile secure service;
4. determining whether the specified mobile telecommunication device 4 is online through the mobile secure server 3, wherein multiple application servers 2 uses the service of the mobile secure server 3 concurrently, if it is negative, the system will go to step (5), if it is positive, the system will go to step (7);
5. sending an online notice message to the specified mobile telecommunication device 4 via the mobile secure server 3, in which the online notice message maybe in various forms, such as a Short Message Service (SMS) message;
6. executing the software of the specified mobile telecommunication device 4 to go online, if the software is not available, the online notice message contains the instruction how to download and/or transmit the software to the specified mobile telecommunication device 4;
7. determining whether the activation time limited is expired through the mobile secure server 3, if it is expired, the system will go to step (8), if it is not expired, the system will go to step (9);
8. sending an activation expired notice message to the specified mobile telecommunication device 4 from the mobile secure server 3 to allow the account user to register the mobile secure service again;
9. sending the activation message to the specified mobile telecommunication device 4 from the mobile secure server 3;
10. generating an account digital ID and certificate (public key) by utilizing the algorithms specified in the activation message, or importing an account digital ID and certificate from other sources, or reusing the existing account digital ID and certificate for the application account; and
storing the account digital ID and certificate in a certificate reservoir together with the application server's certificate; and
submitting the user's account certificate and the authorization code (issued by the application server 2 in step (2)) to the application server 2;
11. verifying the account and the authorization code submitted in step (10), and if it is valid, the application server 2 will sign the submitted account certificate by using the application server's digital ID, and performing other application specific checking, and sending the signed account certificate back to the specified mobile telecommunication device 4; and
12. storing the signed account certificated via the specified mobile telecommunication device 4 to complete the activation process, wherein the user's account is activated and can interact with the application server 2 to authenticate, authorize, encrypt or decrypt the in-coming application requests, various application servers 2 may request different types of account digital IDs and certificates in the certificate reservoir of the specified mobile telecommunication device 4.

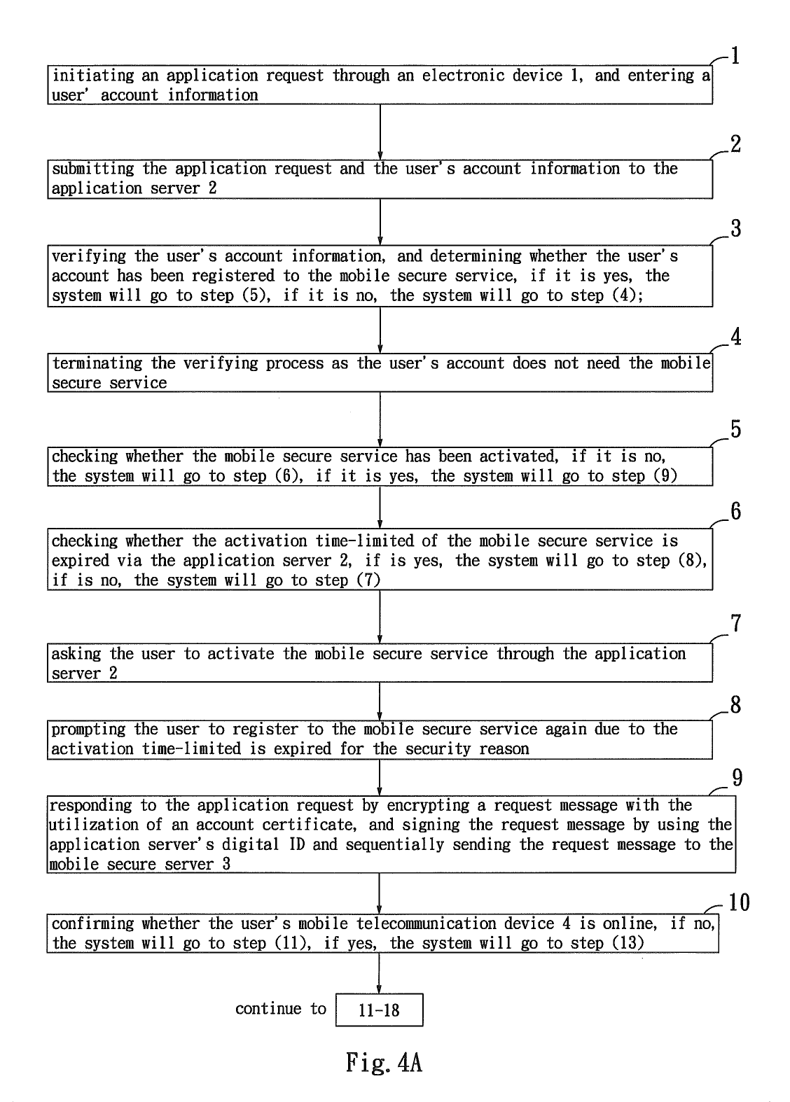

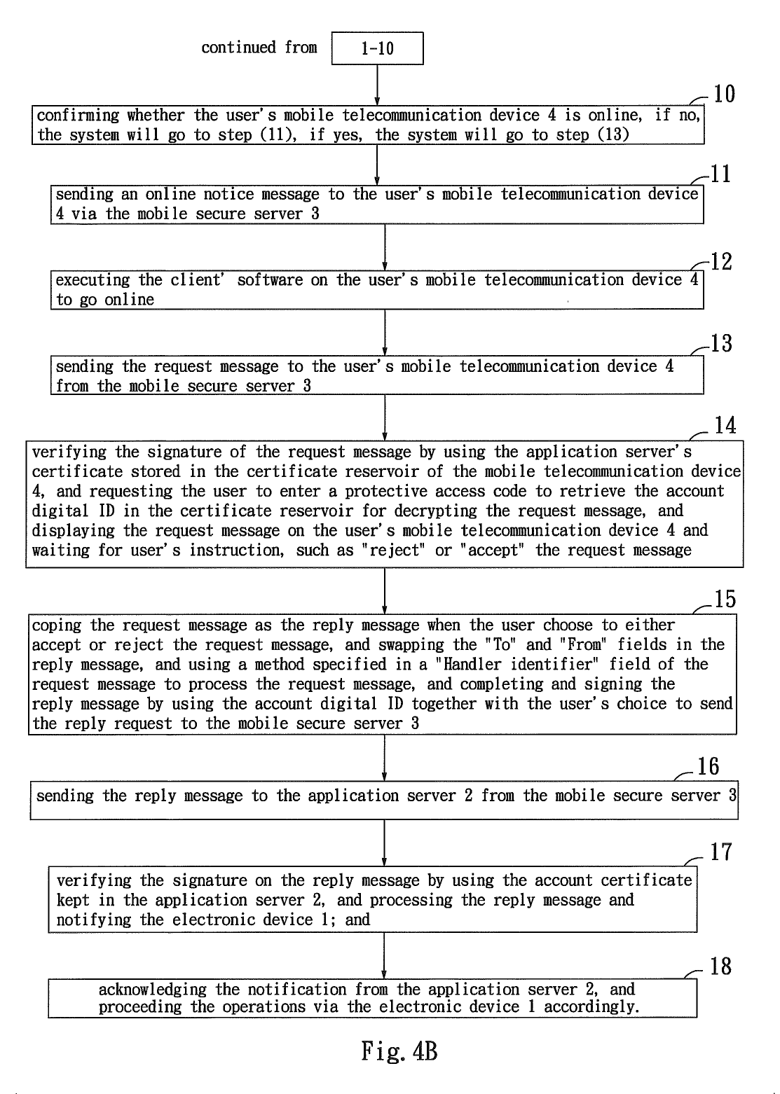

Refer to FIGS. 2, 3, 4A and 4B, the drawings showing how the claimed method is applied, activated and operated, wherein FIG. 2 shows the flow diagram of the method of authenticating, authorizing, encrypting and decrypting an application by utilizing a mobile secure server in accordance with the first preferred embodiment of the present invention, FIG. 3 illustrates the flow diagram of how the method of authenticating, authorizing, encrypting and decrypting an application is applied and activated by utilizing a mobile secure service in accordance with the second preferred embodiment of the present invention, and FIGS. 4A & 4B are the flow diagrams of the processes of the method of authenticating, authorizing, encrypting and decrypting an application by utilizing a mobile secure service with a connection to a user mobile telecommunication device in accordance with a third preferred embodiment of the present invention.

FIGS. 4A & 4B, the processes of the method of authenticating, authorizing, encrypting and decrypting an application by utilizing a mobile secure service with a connection to a user mobile telecommunication device in accordance with a third preferred embodiment of the present invention, comprise:
1. initiating an application request through the electronic device 1, and entering a user' account information, such as, user's name and password, credit card information and/or the identification number of the user's mobile telecommunication device 4;
2. submitting the application request and the user's account information to the application server 2, according to the preferred example of the present invention, the application server 2 can be a bank or a document system;
3. verifying the user's account information, and determining whether the user's account has been registered to the mobile secure service, if it is yes, the system will go to step (5), if it is no, the system will go to step (4);
4. terminating the verifying process as the user's account does not need the mobile secure service;
5. checking whether the mobile secure service has been activated, if it is no, the system will go to step (6), if it is yes, the system will go to step (9);
6. checking whether the activation time-limited of the mobile secure service is expired via the application server 2, wherein the activation time-limited is preset by the application server 2 for the security purpose; if is yes, the system will go to step (8), if is no, the system will go to step (7);
7. asking the user to activate the mobile secure service through the application server 2, in which the application server 2 can optionally provide instructions for downloading, transmitting, installing and executing the client's software on the user's mobile telecommunication device 4;
8. prompting the user to register to the mobile secure service again due to the activation time-limited is expired for the security reason, and terminate;
9. responding to the application request by encrypting the request message with the utilization of an account certificate, and signing the request message by using the application server's digital ID and sequentially sending the request message to the mobile secure server 3;

A request message of the present invention comprises a Header and Body, wherein the Header comprises fields like “From”, “To”, “Handler” and a optional field “Transaction ID”, whereas the Body comprises fields of “Content” and “Private”.

For an example, in an online payment situation, the application request contains:
From: john@firstbank; To: john'smobilephone@mobilesecureserver; Subject: “payment authorization request”; Handler: “STDSIG”;
Transaction ID: 04786; Content: “shows the payment details”; Private data: none;

A data unlocking request message may comprise:
From: tom@gaaiho; To:tom' smobilephone@mobilesecureserverle;
Subject: “file unlock request”; Handler: “STDDEC”;
Transaction ID: none; Content: “shows information of the document to be unlocked”
Private data: a certificate encrypted password.

The optional field “Transaction ID” is assigned and used by the application server 2 to track down each application request, and it is repeated in the reply message, and the Handle identifier “STDSIG” and “STDDEC” are the names for selecting a request handler (method) to be utilized for processing the request message, new Handlers can be written for future requests. Further, the request message is self-sustained and can be processed in the system without other information.
10. confirming whether the user's mobile telecommunication device 4 is online, wherein the user's mobile telecommunication device 4 is connected to the mobile secure server 3 by using the client' software in the user's mobile telecommunication device 4, if no, the system will go to step (11), if yes, the system will go to step (13);
11. sending an online notice message to the user's mobile telecommunication device 4 via the mobile secure server 3;
12. executing the client' software on the user's mobile telecommunication device 4 to be online;
13. sending the request message to the user's mobile telecommunication device 4 from the mobile secure server 3;
14. verifying the signature of the request message in step (9) by using the application certificate stored in the certificate reservoir, requesting the user to enter a protective access code to retrieve the account digital ID in the certificate reservoir for decrypting the request message, and displaying the request message on the user's mobile telecommunication device 4 and waiting for user's instruction, such as “reject” or “accept” the request message;
wherein the choice of the user whether to “accept” or “reject” the request message is the “reason” why the signature appeared on the reply message, and the user's mobile telecommunication device 4 can hold multiple sets of digital ID and the certificate to support the multiple application servers 2; the method of the present invention utilizes a protective code to access a certificate reservoir to retrieve the digital ID stored therein so that the information in the certificate reservoir can be protected and secured, the protective access code is a set of personal numbers or alphabets determined by the owner of the certificate reservoir in order to prevent the digital ID from the illegal access. As a matter of fact, when the user's mobile telecommunication device 4 is lost, the digital ID will still protected by the protective access code. Further, a time interval is pre-set in the system to allow the access of the certificate reservoir within the specified period of time without re-entering the protective access code.
15. coping the request message as the reply message when the user chooses either to accept or reject the request message, and swapping the “To” and “From” fields in the reply message, and using the method specified by the “Handler identifier” field of the request message, to process the request message; for an example, decrypting a password in the “private data” field of the request message, and keeping the decrypted password in the “private data” field of the reply message; completing the reply message and signing the reply message by using the account digital ID together with the user's choice (“reason”) in step (14), either to “accept” or “reject” the request message, and sending the reply request to the mobile secure server 3, wherein the user can encrypt the reply message by using the certificate of the application server 2. Further, the method of the present invention specially designs that the signing of the message must accompany with a “reason” in step (14), in other words, the user must make a choice to accept or reject the request message before the signature is enquired, whereas the encrypting a message is entirely depended on the application user, and when the message has no confidential data, there is no requirement to encrypt the message, such as sending a document digest as the private data;
16. sending the reply message to the application server 2 from the mobile secure server 3;
17. verifying the signature on the reply message by using the account certificate, and processing the reply message and notifying the electronic device 1, wherein the application server 2 can decrypt the reply message by using the digital ID of the application server 2, and the reply message is processed through the system according to its “reason” in the signature of the reply message, such as “accepted” or “rejected” from the user's choice in step (14);
18. acknowledging the notification from the application server 2, and proceeding the operations accordingly.
Regarding how the information have been exchanged and the details of operations performed between the application server 2 and the electronic device 1 are not the main focus of the present invention, as the present invention's main objective is to utilize the mobile secure service to allow the subscribed user to get a document or an application be authenticated, authorized, encrypted and decrypted.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A method of authenticating, authorizing, encrypting and decrypting an application by utilizing a mobile secure server, comprises:
a. sending an application request to an application server;
b. subscribing mobile secure service provided by the mobile secure server, wherein the mobile secure server provides the mobile secure service to the application server, and the received application request is sent to the mobile secure server;
c. sending the application request to a specified mobile telecommunication device, wherein the mobile secure server acts as a gateway without storing or keeping user's account information or the content of the application request;
d. authenticating, authorizing, encrypting or decrypting the application request through the specified mobile telecommunication device, and verifying the application request and determining whether the application request shall be accepted or rejected; and
e. sending a “rejected “or “accepted” signal in respect of the application request back to the mobile secure server, wherein the reply signal will be sent back to the application server from the mobile secure server to reach the electronic device.

2. The method of claim 1, wherein the electronic device of the present invention is a computer, a personal digital assistance (PDA), a printer, a cash register, a cell phone.

3. The method of claim 1, wherein the electronic device is connected to the application server and the application request is sent to the application server from the electronic device.

4. The method of claim 1, wherein the mobile secure server is connected to the application server to offer the mobile communication service to account users, and engages with the specified mobile telecommunication device or a plurality of specified mobile telecommunication devices.

5. The method of claim 1, wherein the specified mobile telecommunication device is a physical device, such as a computer, a personal digital assistance (PDA), a printer, a cash register, a cell phone.

6. The method of claim 1, wherein the application server modifies the database according to the user's account with a certificate and the specified mobile telecommunication device.

7. A method of authenticating, authorizing, encrypting and decrypting an application by utilizing a mobile secure server, comprises:
A subscribing the mobile secure service provided by a mobile secure server,
B registering the mobile secure service offered by the application server by submitting the account user's identification code or number of his/her mobile telecommunication device into the mobile secure server, and receiving an authorization code from the application server for activating the service in step (I);
C sending a time-limited activation message to the mobile secure server from the application server;
D determining whether the specified mobile telecommunication device is online through the mobile secure server, if it is negative, the system will go to step (E), if it is positive, the system will go to step (G);
E sending an online notice message to the specified mobile telecommunication device via the mobile secure server;
F executing the software of the specified mobile telecommunication device to go online;
G determining whether the activation time limited is expired through the mobile secure server, if it is expired, the system will go to step (H), if it is not expired, the system will go to step (I);
H sending an activate expired notice message to the specified mobile telecommunication device from the mobile secure server to allow the account user to register the mobile secure service again;
I sending the time-limited activation message to the specified mobile telecommunication device from the mobile secure server;
J generating an account digital ID and certificate (public key) by utilizing the algorithms specified in the time-limited activation message; and storing the account digital ID and certificate in a certificate reservoir together with the application server's certificate; and submitting the user's account certificate and the authorization code received in step (B) to the application server;
K verifying the account and the authorization code submitted in step (J), and if it is valid, the application server will sign the submitted account certificate by using the application server's digital ID, and associating the signed certificate with the user's account, and sending the signed account certificate back to the specified mobile telecommunication device; and
L storing the signed account certificated via the specified mobile telecommunication device to complete the activation process.

8. The method of claim 7, wherein the application server is connected to the mobile secure service via the mobile secure server, and certificates are exchanged to establish a secure communication between the application server and the mobile secure server.

9. The method of claim 7, wherein in step (B) when the account user receives the authorization code, the account user uses the authorization code to activate the mobile secure service via software used in the mobile telecommunication device, or the account's user downloads the software from a given Universal Resource Locator (URL), or transmits the software to the mobile telecommunication device in order to execute the software to activate the service.

10. The method of claim 7, wherein in step (C) wherein the application server prepares, signs and sends the time-limited activation message to the mobile secure server and then to the specified mobile telecommunication device.

11. The method of claim 10, wherein the time-limited activation message comprises “to” and “from” fields to designate the receiver and the sender.

12. The method of claim 7, wherein in step (D) a plurality of application servers use the service of the mobile secure server concurrently.

13. The method of claim 7, wherein in step (J) the digital ID can be obtained by importing an account digital ID and certificate from other sources, or reusing the existing account digital ID and certificate for the application account.

14. The method of claim 7, wherein in step (L) the user's account is activated and interacted with the mobile secure service to authenticate, authorize, encrypt or decrypt the in-coming application requests, various application servers can stores different types of account digital IDs and certificates in the certificate reservoir of the specified mobile telecommunication device.

15. A method of authenticating, authorizing, encrypting and decrypting an application by utilizing a mobile secure service with a connection to a user mobile telecommunication device, comprises
a initiating an application request through an electronic device, and entering a user' account information;
b submitting the application request and the user's account information to the application server;
c verifying the user's account information, and determining whether the user's account has been registered to the mobile secure service, if it is yes, the system will go to step (e), if it is no, the system will go to step (d);
d terminating the verifying process as the user's account does not need the mobile secure service;
e checking whether the mobile secure service has been activated, if it is no, the system will go to step (f), if it is yes, the system will go to step (i);
f checking whether the activation time-limited of the mobile secure service is expired via the application server, if is yes, the system will go to step (h), if is no, the system will go to step (g);
g asking the user to activate the mobile secure service through the application server;
h prompting the user to register to the mobile secure service again due to the activation time-limited is expired for the security reason;
i responding to the application request by encrypting a request message with the utilization of an account certificate, and signing the request message by using the application server's digital ID and sequentially sending the request message to the mobile secure server;
k confirming whether the user's mobile telecommunication device is online, if no, the system will go to step (l), if yes, the system will go to step (n);
l sending an online notice message to the user's mobile telecommunication device via the mobile secure server;
m executing the client' software on the user's mobile telecommunication device to go online;
n sending the request message to the user's mobile telecommunication device from the mobile secure server;
o verifying the signature of the request message by using the application server's certificate stored in the certificate reservoir of the mobile telecommunication device, and requesting the user to enter a protective access code to retrieve the account digital ID in the certificate reservoir for decrypting the request message, and displaying the request message on the user's mobile telecommunication device and waiting for user's instruction, such as “reject” or “accept” the request message;
p coping the request message as the reply message when the user choose to either accept or reject the request message, and swapping the “To” and “From” fields in the reply message, and using a method specified in a “Handler identifier” field of the request message to process the request message, and completing and signing the reply message by using the account digital ID together with the user's choice to send the reply request to the mobile secure server, and then forwarding the reply message to the application server from the mobile secure server;
q verifying the signature on the reply message by using the account certificate kept in the application server, and processing the reply message and notifying the electronic device; and
r acknowledging the notification from the application server, and proceeding the operations via the electronic device accordingly.

16. The method claim 15, wherein in step (g) the application server can optionally provide instructions for downloading, transmitting, installing and executing the client's software on the user's mobile telecommunication device.

17. The method of claim 15, in step (i) the request message further comprises a Header and a Body, wherein the Header comprises fields like “From”, “To”, “Handler identifier” and an optional field “Transaction ID”, whereas the Body comprises fields of” Content” and “Private”.
